(19) United States
(12) Patent Application Publication
(10) Pub. No.: US 2018/0047290 A1
(43) Pub. Date: Feb. 15, 2018

(54) COLLISION PREVENTION APPARATUS AND SYSTEM FOR PARKING LOT

(71) Applicant: SEONGWON TPS INC., Seoul (KR)

(72) Inventor: Sa Hyun MIN, Goyang-si (KR)

(21) Appl. No.: 15/552,279

(22) PCT Filed: Feb. 1, 2016
(86) PCT No.: PCT/KR2016/001080

§ 371 Date: Aug. 20, 2017

(30) Foreign Application Priority Data
Feb. 17, 2015 (KR) 10-2015-0024353

(51) Int. Cl. G08G 1/16; E01F 9/604; G08B 7/06

(52) U.S. Cl. CPC G08G 1/164; G08G 1/165; G08B 7/066; E01F 9/604

(57) ABSTRACT

The present invention relates to a collision prevention apparatus and system for a parking lot and, more specifically, to an apparatus and system which, when a part of a car is detected within a safety distance, indicates the distance to a parking lot wall or outputs a warning so as to prevent a driver of the car from running the car into the parking lot wall. According to the present invention, the collision prevention apparatus and system for a parking lot is installed on the wall surface of a curved ramp for entering and exiting a parking lot, a pillar in the parking lot, or the like so as to prevent a car from being damaged by a collision with the wall surface of the curved ramp and the edge of the pillar due to inexperienced driving or carelessness, and assist a driver to prevent an accident and properly park his/her car by allowing the driver to accurately recognize the traveling direction of the car and the distance to the wall.

### CROSS-REFERENCE TO RELATED APPLICATIONS

This patent application is a national-stage application of International Patent Application No. PCT/KR2016/001080 which claims priority under 35 U.S.C. § 119 to Korean Patent Application No. 10-2015-0024353, filed on Feb. 17, 2015, in the Korean Intellectual Property Office, the disclosures of which are incorporated by reference herein in their entireties.

### TECHNICAL FIELD

The present invention relates to a collision prevention apparatus and system for parking lot, and more specifically, to an apparatus and system for preventing a car from hitting a ramp wall by outputting an alert or displaying the distance of the car when part of the car is sensed to be within a safe distance.

### DISCUSSION OF RELATED ART

An apartment building, office building, department store, shopping mall, or other buildings have their own underground parking lot intended for parking motor vehicles due to a limited ground parking area.

Sometimes, a car driver is required to drive down the curved ramp to find a parking space in a multi-story car park or the underground parking lot of a building.

In this case, the driver's carelessness or unskillfulness may oftentimes result in a collision with the ramp wall, damaging the car as shown in FIG. 1.

Also frequent is a collision with a concrete column in the underground parking lot while parking the ear on the parking space.

A rear-end accident may ensue as well.

A recent solution to resolve such problems is to put convex mirrors along the curved ramp to alert drivers. Such approach, however, fails to present a satisfactory result because it may rather throw the drivers' sense of distance into confusion. Thus, there is an increasing need for technology that may effectively respond to such issues.

Korean Patent Application No. 10-1998-0048064 discloses a parking alert apparatus that can sense an object near a car being parked and display the distance to the object and outputting an alert when the car approaches within a predetermined distance, thereby attaining safe parking.

However, the prior-art apparatus is not responsive to the likelihood of side-impact collisions with the walls that may arise while getting into the entrance or driving on the curved ramp. Therefore, there is increasing demand for technology to prevent not only head-on or rear-end collisions but also side-impact crashes while driving on the corridor.

### SUMMARY

An object of the present invention is to provide a collision prevention apparatus and system for a parking lot, which can be installed on a column or wall of a curved ramp for entrance or exit from the parking lot to prevent car collisions and helping the driver to properly recognize the direction and distance to the wall, contributing to safe parking.

To achieve the above objects, according to the present invention, there is provided a collision prevention apparatus for a parking lot, comprising a distance sensor for measuring a distance to a vehicle and an alert controller for generating an alert signal depending on the measured distance to the vehicle to alert a driver of the vehicle, wherein the alert controller includes a comparator for detecting when the measured distance to the vehicle is not more than a preset safe distance and an output device for generating an alert signal when the measured distance to the vehicle is not more than the safe distance and outputting the generated alert signal.

Preferably, the output device may adjust and output a color of a light emitting diode (LED) depending on the measured distance to the vehicle.

Preferably, the output device may output the measured distance to the vehicle on a display.

Preferably, the output device may output an alert sound through a speaker when the measured distance to the vehicle is not more than the safe distance.

Preferably, a plurality of alert controllers each packaged in the same housing may be arranged in a row along a wall of a curved ramp of the parking lot, and a plurality of distance sensors may be arranged in a row along the wall of the curved ramp of the parking lot, and each of the distance sensors may be connected with each of the comparator and the output device packaged in the same housing.

Preferably, the distance sensor and the alert controller may be connected with each other via a length-adjustable telescopic pole.

To achieve the above objects, according to the present invention, there is provided a collision prevention system for a parking lot, comprising a plurality of distance sensors installed per section of a predetermined size on a wall of a curved ramp of the parking lot and an alert controller connected with the plurality of distance sensors via wired or wireless communication to gather information about a distance to a vehicle, wherein the distance sensors include a low-hand distance sensor placed on a left-hand wall of the curved ramp to measure a display to the vehicle and a right-hand distance sensor placed on a right-hand wall of the curved ramp to measure a distance to the vehicle, wherein the alert controller is placed per section in a one-by-one manner, gathers the measured distance to the vehicle from the left-hand distance sensor and the right-hand distance sensor placed in each section, detects when the gathered distance to the vehicle is not more than a preset safe distance, and when the gathered distance to the vehicle is not more than the preset safe distance, generates an alert signal, and outputs the generated alert signal.

Preferably, the alert controller may adjust and output a color of an LED depending on the extracted left-hand shortest distance and the right-hand shortest distance.

Preferably, the alert controller may further include a left-hand display for outputting the extracted left-hand shortest distance on a screen and a right-hand display for outputting the extracted right-hand shortest distance on a screen.

Preferably, when at least one of the extracted left-hand shortest distance and the extracted right-hand shortest distance is not more than the safe distance, the alert controller may output an alert sound through an internal speaker.

Preferably, the alert controller placed per section in a one-by-one manner may communicate with another alert controller, and when an alert signal is generated, the alert controller may transmit the generated alert signal to a nearby alert controller, and the nearby alert controller may output an alert sound through an external speaker.

According to the present invention, a collision prevention apparatus and system for a parking lot can be installed on a column or wall of a curved ramp for entrance or exit from the parking lot to prevent car collisions and helping the driver to properly recognize the direction and distance to the wall, contributing to safe parking.

### BRIEF DESCRIPTION OF THE DRAWINGS

FIG. 1 is a view illustrating an example of car collision into a wall of a curved corridor on a car park ramp;

FIG. 2 is a block diagram illustrating a collision prevention apparatus for a parking lot according to an embodiment of the present invention;

FIGS. 3 and 4 are views illustrating a collision prevention apparatus for a parking lot according to an embodiment of the present invention;

FIGS. 5 and 6 are views illustrating examples of collision prevention apparatuses installed in a parking lot as shown in FIGS. 2 to 4;

FIG. 7 is a view illustrating an example of a collision prevention apparatus for a parking lot according to another embodiment of the present invention;

FIG. 8 is a view illustrating an example of a collision prevention system for a parking lot according to an embodiment of the present invention; and

FIG. 9 is a block diagram illustrating a collision prevention system 200 for a parking lot according to an embodiment of the present invention.

### DETAILED DESCRIPTION OF EXEMPLARY EMBODIMENTS

Various changes may be made to the present invention, and the present invention may come with a diversity of embodiments. Some embodiments of the present invention are shown and described in connection with the drawings. However, it should be appreciated that the present invention is not limited to the embodiments, and all changes and/or equivalents or replacements thereto also belong to the scope of the present invention.

The terms “first” and “second” may be used to describe various components, but the components should not be limited by the terms. The terms are used only to distinguish one component from another. For example, a first component may be denoted a second component, and vice versa without departing from the scope of the present disclosure.

The terms as used herein are provided merely to describe some embodiments thereof, but not to limit the present disclosure. It is to be understood that the singular forms “a,” “an,” and “the” include plural references unless the context clearly dictates otherwise. It will be further understood that the terms “comprise” and/or “have,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms including technical and scientific terms used herein have the same meaning as commonly understood by one of ordinary skill in the art to which the embodiments of the present disclosure belong.

It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, preferred embodiments of the present invention are described in detail with reference to the accompanying drawings. The same reference denotations are used to refer to the same members throughout the drawings.

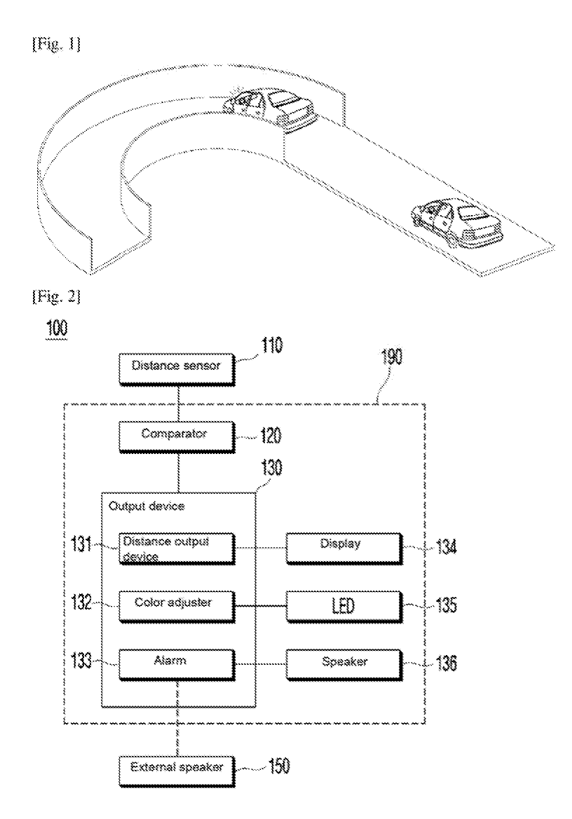

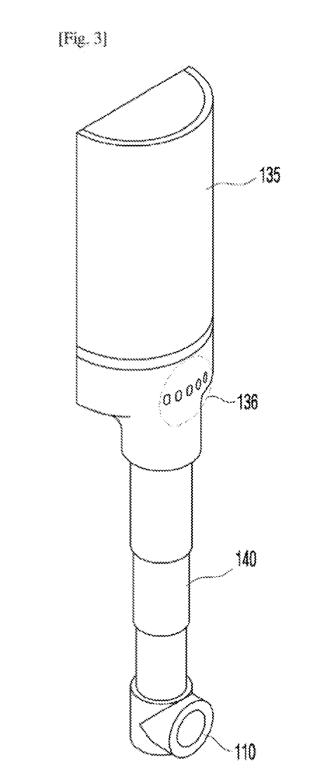

FIG. 2 is a block diagram illustrating a collision prevention apparatus for a parking lot according to an embodiment of the present invention.

Referring to FIG. 2, according to an embodiment of the present invention, a collision prevention apparatus 100 for a parking lot is attached onto the wall or column of the parking lot or the wall of a curved ramp to the parking lot. The collision prevention apparatus 100 includes a distance sensor 110 and an alarm controller 190.

The distance sensor 110 includes a sensor that may sense the distance to an object. The distance sensor 110 may be installed on the wall or column of the parking lot or the wall of the curved ramp to the parking lot to measure the distance to a vehicle. As the distance sensor, an infrared (IR) sensor or an ultrasound sensor may be used to measure the distance to an object. The distance sensor falls within known technology and no detailed description thereof is given.

The alarm controller 190 generates an alert signal depending on the measured distance to the vehicle to alert the driver. The alarm controller 190 includes a comparator 120 and an output device 130. The alarm controller 190 may further include at least one of a display 134, a light emitting diode (LED) 135, and a speaker 136.

The comparator 120 compares the distance to the vehicle measured through the distance sensor 110 with a preset safe distance to detect when the measured distance to the vehicle is the safe distance or less.

When the measured distance to the vehicle is the safe distance or less, the output device 130 generates and outputs an alert signal.

Meanwhile, to provide the driver with a different alert message per distance, the comparator 120 may compare the measured distance to the vehicle with a preset dangerous distance in addition to the comparison with the safe distance. When the measured distance to the vehicle is the dangerous distance or less, the output device 130 may additionally generate and output a danger signal.

For example, where the safe distance is 30 cm, the dangers distance is 15 cm, and the distance between the wall and the vehicle is 40 cm, neither an alert signal nor a danger signal may be generated. Where the distance between the wall and the vehicle exceeds 15 cm and is not more than 30 cm, an alert signal may be generated, and where the distance between the wall and the vehicle is not more than 15 cm, a danger signal may be generated.

The output device 130 may include at least one of a distance output device 131, a color adjuster 132, and an alarm 133.

The distance output device 131 performs control to receive the measured distance to the vehicle, digitize the received distance, and output the digitized distance on the display 134. The driver may be aware how far the vehicle is away from the wall by checking the distance to the vehicle which is outputted through the display 134.

The color adjuster 132 performs control to change the color of the LED 135 and output the changed color depending on the measured distance to the vehicle. For example, where the measured distance to the vehicle exceeds the safe distance, the color adjuster 132 may perform control so that a green LED lights on, where the measured distance to the vehicle exceeds the dangerous distance and is not more than the safe distance, the color adjuster 132 may perform control so that a yellow or orange LED lights on, and where the measured distance to the vehicle is not more than the dangerous distance, the color adjuster 132 may perform control so that a red LED lights on. Where the safe distance is set up but the dangerous distance is not, the color adjuster 132 may perform control so that two LEDs, e.g., a green LED and a red LED, light on.

The above-described safe distance and dangerous distance are not limited to the foregoing and may rather be set to distances appropriate for various environments, e.g., the size of the parking lot or the width of the curved ramp. The color of the LED depending on the measured distance between the wall and the vehicle may also be varied depending on contexts.

Where the measured distance to the vehicle is not more than the safe distance, the alarm 133 may perform control to output an alert sound through its embedded speaker 136. The alarm 133 may perform control to output different alert sounds, e.g., from a first alert sound to a nth alert sound, stepwise depending on the measured distance between the wall and the vehicle, allowing the driver to predict the distance between the wall and the vehicle by simply hearing the alert sounds. Alternatively, the alarm 133 may allow the driver to predict the distance between the wall and the vehicle by performing control so that the duration that the alert sound goes off is changed, e.g., shortened, as the distance between the wall and the vehicle decreases.

The collision prevention apparatus 100 may be connected with an external speaker 150 to alert another following vehicle to the vehicle in front being close to the wall so that the other vehicle can slow down. In this case, the output device 130 may be connected, through wired or wireless communication, with the external speaker 150 which is positioned nearby. When an alert signal is generated, the output device 130 may generate a remote alert signal and transmit the generated remote alert signal to the external speaker 150 so that the external speaker 150 may output an alert sound.

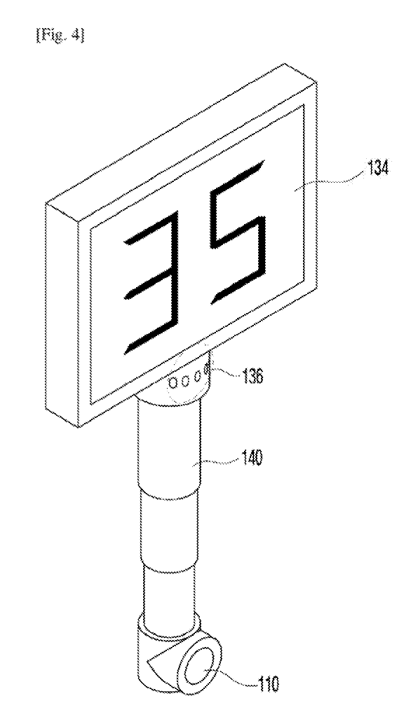

FIGS. 3 and 4 are views illustrating a collision prevention apparatus for a parking lot according to an embodiment of the present invention.

The collision prevention apparatus of FIG. 3 allows the driver to predict the distance between the vehicle and the wall by controlling the LED 135 to change and output its color depending on the distance between the vehicle and the wall.

To that end, the collision prevention apparatus of FIG. 3 externally includes a distance sensor 110 and an LED 135 and includes an alert controller 190 inside its housing. The collision prevention apparatus includes a speaker 136 for outputting alert sound and a length-adjustable telescopic pole 140 for installation and attachment onto the wall of a parking lot in various environments. Cables for power feeding and information transmission may be provided inside the telescopic pole 140 to connect the distance sensor 110 with the alert controller 190 in the housing.

The collision prevention apparatus of FIG. 4 directly informs the driver of the distance between the wall and the vehicle by outputting the measured distance between the wall and the vehicle through the display 134. To that end, similar to the collision prevention apparatus of FIG. 3, the collision prevention apparatus of FIG. 4 includes a distance sensor 110 and an LED 135 and includes an alert controller 190 inside its housing, and the collision prevention apparatus of FIG. 4 includes a length-adjustable telescopic pole.

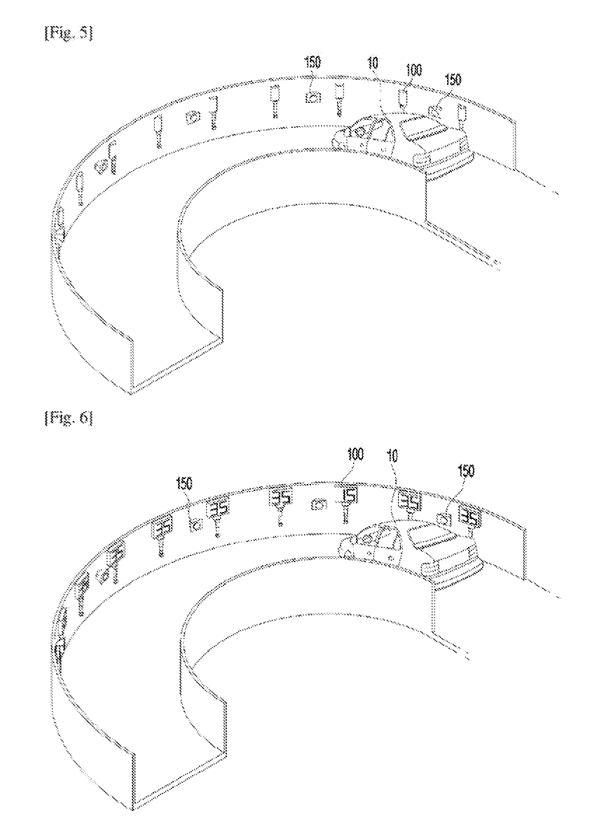

FIGS. 5 and 6 are views illustrating examples of collision prevention apparatuses installed in a parking lot as shown in FIGS. 2 to 4.

FIG. 5 shows an example in which the collision prevention apparatus 100 of FIG. 3 is installed at a curved ramp to a parking lot, and FIG. 6 shows an example in which the collision prevention apparatus 100 of FIG. 4 is installed at a curved ramp to a parking lot.

As the vehicle approaches the wall, the driver may suddenly speed down or stop the car. Thus, when the vehicle ahead comes closer to the wall, the external speaker 150 may output an alert sound to the tailing car's driver to predict the sudden speed-down or stopping of the car ahead.

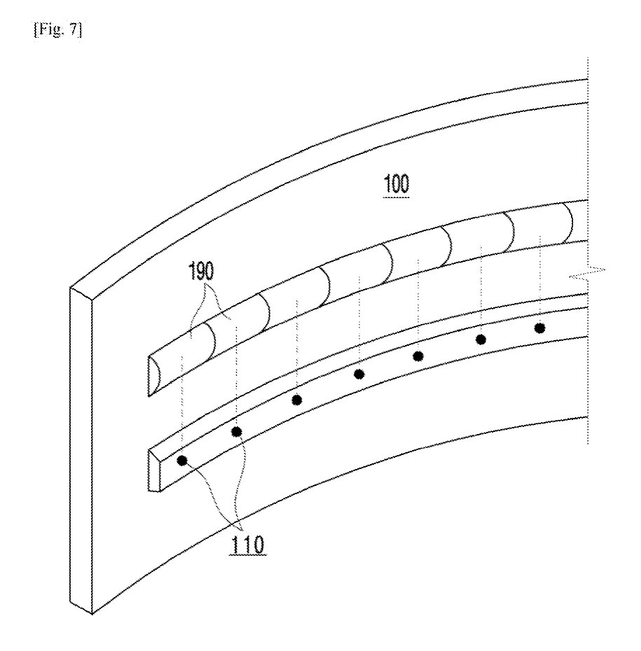

FIG. 7 is a view illustrating an example of a collision prevention apparatus for a parking lot according to another embodiment of the present invention.

Referring to FIG. 7, for easier installation, at a curved ramp of a parking lot, of the collision prevention apparatus, the comparator and the output device of the alert controller 190 may be included in the same housing, and the alert controller 190 and the distance sensor 110 are connected with the distance sensor 110 in a one-to-one manner through wired or wireless communication.

In other words, a plurality of alert controllers 190, each packaged in the same housing, are arranged in a row along the wall of the curved ramp of the parking lot, and a plurality of distance sensors 110 are arranged in a row along the wall of the curved ramp of the parking lot. Each of the plurality of alert controllers 190 is connected with a corresponding one of the plurality of distance sensors 110 in a one-to-one correspondence.

The alert controllers 190 and the distance sensors 110 may be powered from an external source and may be connected together in a one-to-one correspondence via wired or wireless communication.

According to the present invention, schemes for the wireless communication may include at least one of predetermined short-range communication means, e.g., conventional short-range wireless communication means including infrared (IR) communication, radio frequency (RF) communication, Bluetooth, Wireless LAN, wireless-fidelity (Wi-Fi), and Zigbee, and/or all types of short-range wireless communication means to be equipped in the wireless terminal 100 in the future.

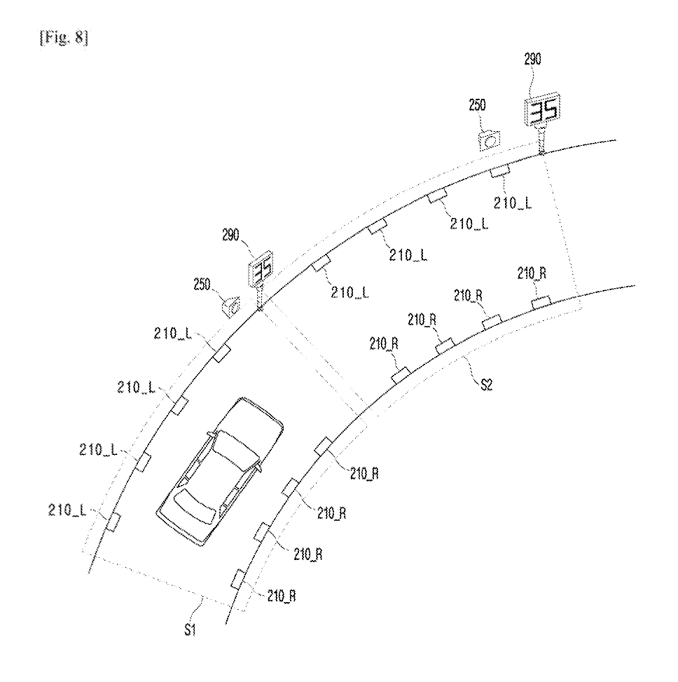

FIG. 8 is a view illustrating an example of a collision prevention system for a parking lot according to an embodiment of the present invention.

Referring to FIG. 8, according to an embodiment of the present invention, a collision prevention system includes a plurality of distance sensors 210_L and 210_R that are installed on the wall of the curved ramp of the parking lot in each section of a predetermined size, and alert controllers 290 connected with the plurality of distance sensors 210_L and 210_R via wired or wireless communication to gather information about the distance to the vehicle.

The distance sensors include left-hand distance sensors 210_L which are arranged on the left-hand wall of the curved ramp to measure the distance to the vehicle and right-hand distance sensors 210_R which are arranged on the right-hand wall of the curved ramp to measure the distance to the vehicle.

One alert controller 290 is placed in each section S1 or S2 to gather the distance to the vehicle which is measured from the left-hand distance sensors 210_L and the right-hand distance sensors 210_R arranged in the section, and the alert controller 290 detects when the distance gathered is not more than a preset safe distance, and when the distance is not more than the preset safe distance, generates and outputs an alert signal.

Preferably, the alert controllers 290 may be installed at the outside of the wall with respect to the direction in which the vehicle travels to effectively inform the driver of the distance between the wall and the vehicle. However, the alert controllers 290 may be installed at the inside of the wall depending on contexts. As described above in connection with FIG. 2, a dangerous distance may be set up in addition to the safe distance.

Although two sections S1 and S2 are shown in FIG. 8, the number of sections is not limited thereto and is determined depending on the length of the curved ramp or the size of each section. For example, the number of sections may be significantly increased as the curved ramp is longer or more and more levels are put to access the underground parking lot.

As shown in FIG. 8, each section has one alert controller 290. The alert controller 290 in a certain section collects the measured distance between the wall and the vehicle from the distance sensors 210_L and 210_R installed in the section. Each alert controller 290 and each distance sensor 210_L and 210_R may have its own unique identity (ID). Thus, upon first installing the alert controllers 290 and the distance sensors 210_L and 210_R, the distance sensors 210_L and 210_R in each section are set to perform wired or wireless communication with the alert controller 290 alone which belongs to the corresponding section.

For connection via wired communication, the alert controller 290 and the distance sensors 210_L and 210_R which belong to a corresponding section may be connected together through communication cables. Upon first installing the alert controllers 290 and the distance sensors 210_L and 210_R, the alert controller 290 that belongs to a particular section may store the IDs of the distance sensors 210_L and 210_R belonging to the particular section and identify the distance sensors 210_L and 210_R, so that the alert controller 290 may communicate with only the distance sensors 210_L and 210_R belonging to the particular section.

The alert controller 290 may include a display screen able to output numbers or an LED able to change colors so that the alert controller 290 may generate an alert signal and output the alert signal through the display or LED when a vehicle passing through the particular section approaches the wall, previously alerting the drivers to the danger that the vehicle may hit the wall of the curved ramp of the parking lot.

Meanwhile, an external speaker 250 may be provided near the alert controller 290 to alert the driver or the tailing car's driver when the alert signal is generated.

FIG. 9 is a block diagram illustrating a collision prevention system 200 for a parking lot according to an embodiment of the present invention.

Referring to FIG. 9, according to an embodiment of the present invention, a collision prevention system 200 for a parking lot includes a plurality of distance sensors installed per section of a predetermined size on the wall of a curved ramp of the parking lot and alert controllers connected with the plurality of distance sensors via wired or wireless communication to gather information about the distance to a vehicle.

Although a plurality of alert controllers and a plurality of distance sensors are arranged along the curved ramp of the parking lot, an example is described in one alert controller 290 and one distance sensor 210 are provided for ease of description.

The distance sensor 210 include a left-hand distance sensor 210_L which is placed on the left-hand wall of the curved ramp to measure the distance to the vehicle and a right-hand distance sensor which is placed on the right-hand wall of the curved ramp to measure the distance to the vehicle, and the distance sensor 210 transmits the measured distance to the vehicle to the alert controller 290 via wired or wireless communication.

One alert controller 290 is placed in each section, gathers the measured distance to the vehicle from the left-hand distance sensor and the right-hand distance sensor in the section, detects when the gathered distance to the vehicle is not more than a preset safe distance, and when the gathered distance to the vehicle is not more than the safe distance, generates and outputs an alert signal. The alert controller 290 includes at least one of a collector 280, a comparator 220, and an output device 230.

The collector 280 gathers the measured distance to the vehicle from each of the left-hand distance sensor and the right-hand distance sensor placed in each section.

The comparator 220 extracts a shortest distance to the left from the distance to the vehicle gathered from the left-hand distance sensor and a shortest distance to the right from the display to the vehicle gathered from the right-hand display sensor.

The output device 230 generates an alert signal when at least one of the extracted left-hand shortest distance and right-hand shortest distance is not more than the safe distance. The output device 230 may include at least one of a distance output device 231, a color adjuster 232, and an alarm 233.

The distance output device 231 performs control to output the extracted left-hand shortest distance and right-hand shortest distance on a left-hand display 234_L and a right-hand display 234_R, respectively. The display 234 may be implemented to have two displays that are joined together. The display 234 includes the left-hand display 234_L and the right-hand display 234_R. As the extracted left-hand shortest distance is outputted on the left-hand display 234_L, and the extracted right-hand shortest distance is outputted on the right-hand display 234_R, the driver may check on the display 234 the shortest distance between the left-hand wall and the vehicle or between the right-hand wall and the vehicle, thereby being put on notice how far the vehicle is away from the left-hand wall and the right-hand wall.

The color adjuster 232 controls a left-hand LED 235_L and a right-hand LED 235_R to change and output its color depending on the extracted left-hand shortest distance and the extracted right-hand shortest distance. For example, where the extracted shortest distance exceeds the safe distance, the color adjuster 132 may perform control so that a green LED lights on, where the extracted shortest distance exceeds the dangerous distance and is not more than the safe distance, the color adjuster 132 may perform control so that a yellow or orange LED lights on, and where the extracted shortest distance is not more than the dangerous distance, the color adjuster 132 may perform control so that a red LED lights on. Where the safe distance is set up but the dangerous distance is not, the color adjuster 132 may perform control so that two LEDs, e.g., a green LED and a red LED, light on.

The above-described safe distance and dangerous distance are not limited to the foregoing and may rather be set to distances appropriate for various environments, e.g., the size of the parking lot or the width of the curved ramp. The color of the LED depending on the measured distance between the wall and the vehicle may also be varied depending on contexts.

The LED may include the left-hand LED 235_L and the right-hand LED 235_R to indicate which one of the left-hand wall and the right-hand wall the vehicle approaches.

Where at least one of the extracted left-hand shortest distance and the extracted right-hand shortest distance is not more than the safe distance, the alarm 133 may perform control to output an alert sound through its embedded speaker 236. As described above, the alarm 133 may perform control to output different alert sounds, e.g., from a first alert sound to a nth alert sound, stepwise depending on the measured distance between the left-hand or right-hand wall and the vehicle, allowing the driver to predict the distance between the wall and the vehicle by simply hearing the alert sounds. Alternatively, the alarm 133 may allow the driver to predict the distance between the wall and the vehicle by performing control so that the duration that the alert sound goes off is changed, e.g., shortened, as the distance between the wall and the vehicle decreases.

The collision prevention system 200 may be connected with an external speaker (not shown) to alert another following vehicle to the vehicle in front being close to the wall so that the other vehicle can slow down.

The alert controllers placed one-by-one per section may mutually communicate with each other via wired or wireless communication. When an alert signal is generated, the alert controller may transmit the generated alert signal to a nearby alert controller(s), and the nearby alert controller(s) may output an alert sound(s) through the external speaker.

While the present invention has been shown and described with reference to specific embodiments thereof, it will be apparent to those of ordinary skill in the art that the embodiments are merely an example and that various changes in form and detail may be made thereto without departing from the spirit and scope of the present invention as defined by the following claims. The scope of the present invention should be construed by the following claims, and all technical spirits within equivalents thereof should be interpreted to belong to the scope of the present invention.

1. A collision prevention apparatus for a parking lot, comprising:
a distance sensor for measuring a distance to a vehicle; and
an alert controller for generating an alert signal depending on the measured distance to the vehicle to alert a driver of the vehicle, wherein the alert controller includes a comparator for detecting when the measured distance to the vehicle is not more than a preset safe distance and an output device for generating an alert signal when the measured distance to the vehicle is not more than the safe distance and outputting the generated alert signal.

2. The collision prevention apparatus of claim 1, wherein the output device adjusts and outputs a color of a light emitting diode (LED) depending on the measured distance to the vehicle.

3. The collision prevention apparatus of claim 1, wherein the output device outputs the measured distance to the vehicle on a display.

4. The collision prevention apparats of claim 1, wherein the output device outputs an alert sound through a speaker when the measured distance to the vehicle is not more than the safe distance.

5. The collision prevention apparatus of claim 1, wherein a plurality of alert controllers each packaged in the same housing are arranged in a row along a wall of a curved ramp of the parking lot, and a plurality of distance sensors are arranged in a row along the wall of the curved ramp of the parking lot, and wherein each of the distance sensors is connected with each of the comparator and the output device packaged in the same housing.

6. The collision prevention apparatus of claim 1, wherein the distance sensor and the alert controller are connected with each other via a length-adjustable telescopic pole.

7. A collision prevention system for a parking lot, comprising a plurality of distance sensors installed per section of a predetermined size on a wall of a curved ramp of the parking lot and an alert controller connected with the plurality of distance sensors via wired or wireless communication to gather information about a distance to a vehicle, wherein the distance sensors include a low-hand distance sensor placed on a left-hand wall of the curved ramp to measure a display to the vehicle and a right-hand distance sensor placed on a right-hand wall of the curved ramp to measure a distance to the vehicle, wherein the alert controller is placed per section in a one-by-one manner, gathers the measured distance to the vehicle from the left-hand distance sensor and the right-hand distance sensor placed in each section, detects when the gathered distance to the vehicle is not more than a preset safe distance, and when the gathered distance to the vehicle is not more than the preset safe distance, generates an alert signal, and outputs the generated alert signal.

8. The collision prevention system of claim 7, wherein the alert controller extracts a left-hand shortest distance from the distance to the vehicle gathered from the low-hand distance sensor and a right-hand shortest distance from the distance to the vehicle gathered from the right-hand distance sensor, and when at least one of the extracted left-hand shortest distance and the extracted right-hand shortest distance is not more than the safe distance, generates the alert signal.

9. The collision prevention system of claim 8, wherein the alert controller adjusts and outputs a color of an LED depending on the extracted left-hand shortest distance and the right-hand shortest distance.

10. The collision prevention system of claim 7, wherein the alert controller further includes a left-hand display for outputting the extracted left-hand shortest distance on a screen and a right-hand display for outputting the extracted right-hand shortest distance on a screen.

11. The collision prevention system of claim 7, wherein when at least one of the extracted left-hand shortest distance and the extracted right-hand shortest distance is not more than the safe distance, the alert controller outputs an alert sound through an internal speaker.

12. The collision prevention system of claim 7, wherein the alert controller placed per section in a one-by-one manner communicates with another alert controller, and when an alert signal is generated, the alert controller transmits the generated alert signal to a nearby alert controller, and the nearby alert controller outputs an alert sound through an external speaker.

13. The collision prevention apparatus of claim 2, wherein the output device outputs an alert sound through a speaker when the measured distance to the vehicle is not more than the safe distance.

14. The collision prevention apparatus of claim 3, wherein the output device outputs an alert sound through a speaker when the measured distance to the vehicle is not more than the safe distance.

15. The collision prevention apparatus of claim 2, wherein a plurality of alert controllers each packaged in the same housing are arranged in a row along a wall of a curved ramp of the parking lot, and a plurality of distance sensors are arranged in a row along the wall of the curved ramp of the parking lot, and wherein each of the distance sensors is connected with each of the comparator and the output device packaged in the same housing.

16. The collision prevention apparatus of claim 3, wherein a plurality of alert controllers each packaged in the same housing are arranged in a row along a wall of a curved ramp of the parking lot, and a plurality of distance sensors are arranged in a row along the wall of the curved ramp of the parking lot, and wherein each of the distance sensors is connected with each of the comparator and the output device packaged in the same housing.
